(19) United States
(12) Patent Application Publication
(10) Pub. No.: US 2021/0402996 A1
(43) Pub. Date: Dec. 30, 2021

(54) VEHICLE CONTROL DEVICE

(71) Applicant: TOYOTA JIDOSHA KABUSHIKI KAISHA, Toyota-shi (JP)

(72) Inventor: Chenyu Wang, Toyota-shi (JP)

(73) Assignee: TOYOTA JIDOSHA KABUSHIKI KAISHA, Toyota-shi (JP)

(21) Appl. No.: 17/325,596

(22) Filed: May 20, 2021

(30) Foreign Application Priority Data
Jun. 29, 2020 (JP) 2020-111900

(51) Int. Cl. B60W 30/18; B60W 40/08; B60W 40/105; B60W 50/14

(52) U.S. Cl. CPC B60W 30/181; B60W 40/08; B60W 40/105; B60W 2554/802; B60W 2540/229; B60W 2540/221; B60W 50/14

(57) ABSTRACT

A vehicle control device executes a warning control for a driver when the driver is in an abnormal state, and executes a stop control for stopping an own vehicle when the abnormal state is continued for a predetermined time threshold or more from a time point at which the warning control is started. In a first period from a time point at which the warning control is started to a time point at which the stop control is started, the vehicle control device determines whether there is another vehicle behind the own vehicle, and when the control device determines that there is no other vehicle behind the own vehicle, a specific deceleration control that temporarily decelerates the own vehicle is executed.

### CROSS-REFERENCE TO RELATED APPLICATION

This application claims priority to Japanese Patent Application No. 2020-111900 filed on Jun. 29, 2020, incorporated herein by reference in its entirety.

### BACKGROUND

### 1. Technical Field

The present disclosure relates to a vehicle control device configured to stop a vehicle when it is determined that a driver is in an abnormal state.

### 2. Description of Related Art

Conventionally, a device for executing a control of forcibly stopping a vehicle (hereinafter referred to as a “conventional device”) when it is determined that a driver is in an abnormal state has been proposed (for example, see Japanese Unexamined Patent Application Publication No. 2010-125923 (JP 2010-125923 A)). Here, the abnormal state means a state in which the driver has lost the ability to drive a vehicle, and includes, for example, a dozing driving state and a mental and physical dysfunction state.

When the conventional device determines that the driver is in an abnormal state, the conventional device executes a warning control for the driver as a first stage processing. For example, in the conventional device, a buzzer sounds a warning sound and a warning lamp is displayed on an indicator. Thereafter, when the abnormal state continues for a predetermined time or more from the time point at which the warning control is started, the conventional device executes the stop control for stopping the vehicle as the next stage processing.

### SUMMARY

When the driver is in a dozing state, it is required to awaken the driver as soon as possible. However, the conventional device only executes the warning control as the first stage processing. When the driver is in the dozing state, the conventional device may not be able to waking up the driver since the conventional device can only stimulate the driver with a warning sound.

The present disclosure has been made to solve the above problems. That is, one object of the present disclosure is to provide a vehicle control device capable of waking up the driver earlier than the conventional device when a driver is in a dozing state.

A vehicle control device of the present disclosure includes: an operation amount sensor that acquires information about an operation amount of a driving operator operated by a driver of an own vehicle to drive the own vehicle; a rear sensor that detects object information that is information about an object that is in a rear region of the own vehicle; a control device that is configured to repeatedly determine whether the driver is in an abnormal state in which the driver has lost an ability to drive the own vehicle while the own vehicle is traveling, based on the information about the operation amount of the driving operator, execute a warning control to the driver when the control device determines that the driver is in an abnormal state, and execute a stop control for stopping the own vehicle when the abnormal state is continued for a predetermined time threshold value or more from a time point at which the warning control is started. The control device is configured to determine whether there is another vehicle behind the own vehicle, based on the object information, in a first period from the time point at which the warning control is started to a time point at which the stop control is started, and execute a specific deceleration control for temporarily decelerating the own vehicle so as to give the driver a feeling of deceleration when the control device determines that there is no other vehicle behind the own vehicle.

When the control device determines that there is no other vehicle behind the own vehicle, the vehicle control device executes specific deceleration control in addition to the warning control. When the driver is in the dozing state, the vehicle control device can give the driver a feeling of deceleration and awaken the driver faster than the conventional device.

In one aspect of the present disclosure, the control device is configured to execute a speed maintaining control for maintaining a speed of the own vehicle when the control device determines that there is the other vehicle behind the own vehicle in the first period.

According to the above configuration, the vehicle control device maintains the speed of the own vehicle when another vehicle is behind the own vehicle. Since the own vehicle is not decelerated, it is possible to prevent the own vehicle from approaching the other vehicle.

In one aspect of the present disclosure, the control device is configured to determine whether there is the other vehicle behind the own vehicle every time a predetermined time elapses in the first period, and execute the specific deceleration control when the control device determines that there is no other vehicle behind the own vehicle VA.

According to the above configuration, when there is no other vehicle behind the own vehicle, the vehicle control device repeatedly gives the driver a feeling of deceleration. Therefore, the possibility of awakening the driver can be increased.

In one aspect of the present disclosure, the control device is configured to execute the specific deceleration control, when the control device determines that a predetermined condition that is satisfied when a probability that the own vehicle approaches the other vehicle is low by the specific deceleration control is satisfied, even when the control device determines that there is the other vehicle behind the own vehicle.

According to the above configuration, the vehicle control device can wake up the driver by executing the specific deceleration control in accordance with the satisfaction of a predetermined condition even when the other vehicle is present behind the own vehicle.

In one aspect of the present disclosure, the control device is configured to determine whether the predetermined condition is satisfied, by using one or both of an inter-vehicle distance between the own vehicle and the other vehicle and a relative speed of the other vehicle with respect to the own vehicle.

In one aspect of the present disclosure, the control device is configured to set a value of a deceleration parameter in the specific deceleration control when there is the other vehicle behind the own vehicle, to be smaller than a value when there is no other vehicle behind the own vehicle, and the deceleration parameter includes at least one of an amount of change in an acceleration of the own vehicle and a time change rate of the acceleration.

According to the above configuration, when there is the other vehicle behind the own vehicle, the vehicle control device can decrease the degree of deceleration of the own vehicle by the specific deceleration control, as compared to a case in which there is no other vehicle behind the own vehicle. Therefore, it is possible to reduce the possibility that the own vehicle approaches the other vehicle.

In one aspect of the present disclosure, the control device is configured to change a value of the deceleration parameter in the specific deceleration control in accordance with one or both of an inter-vehicle distance between the own vehicle and the other vehicle and a relative speed of the other vehicle with respect to the own vehicle, and the deceleration parameter includes at least one of an amount of change in an acceleration of the own vehicle and a time change rate of the acceleration.

In one or more embodiments, the control device described above may be implemented by a microprocessor programmed to execute one or more of the functions described herein. In one or more embodiments, the control device may be implemented in whole or in part by an integrated circuit specialized for one or more applications, that is, a hardware configured by an ASIC or the like. In the above description, in order to help the understanding of the present disclosure, the names and/or symbols used in the embodiments are added in parentheses, in the configurations of the disclosure corresponding to the embodiments described below. However, each component of the present disclosure is not limited to the embodiments defined by the above name and/or symbol.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control device according to one or more embodiments;

FIG. 2 is a diagram for describing an operation of the vehicle control device;

FIG. 3 is a diagram for explaining the operation of the vehicle control device in a first mode;

FIG. 4 is a diagram for explaining the operation of the vehicle control device in the first mode;

FIG. 5 is a flowchart showing an “abnormal state determination routine” executed by a CPU of an operation support ECU (hereinafter, simply referred to as a “CPU”);

FIG. 6 is a flowchart showing a “first mode control routine” executed by the CPU;

FIG. 7 is a flowchart showing a “deceleration/speed maintaining control routine” executed by the CPU in step 605 in FIG. 6;

FIG. 8 is a flowchart showing a “second mode control routine” executed by the CPU;

FIG. 9 is a flowchart showing a “third mode control routine” executed by the CPU;

FIG. 10 is a flowchart showing a “fourth mode control routine” executed by the CPU;

FIG. 11 is a flowchart showing a modified example of the “deceleration/speed maintaining control routine” executed by the CPU in step 605 in FIG. 6; and

FIG. 12 is a flowchart showing a modified example of the “deceleration/speed maintaining control routine” executed by the CPU in step 605 in FIG. 6.

### DETAILED DESCRIPTION OF EMBODIMENTS

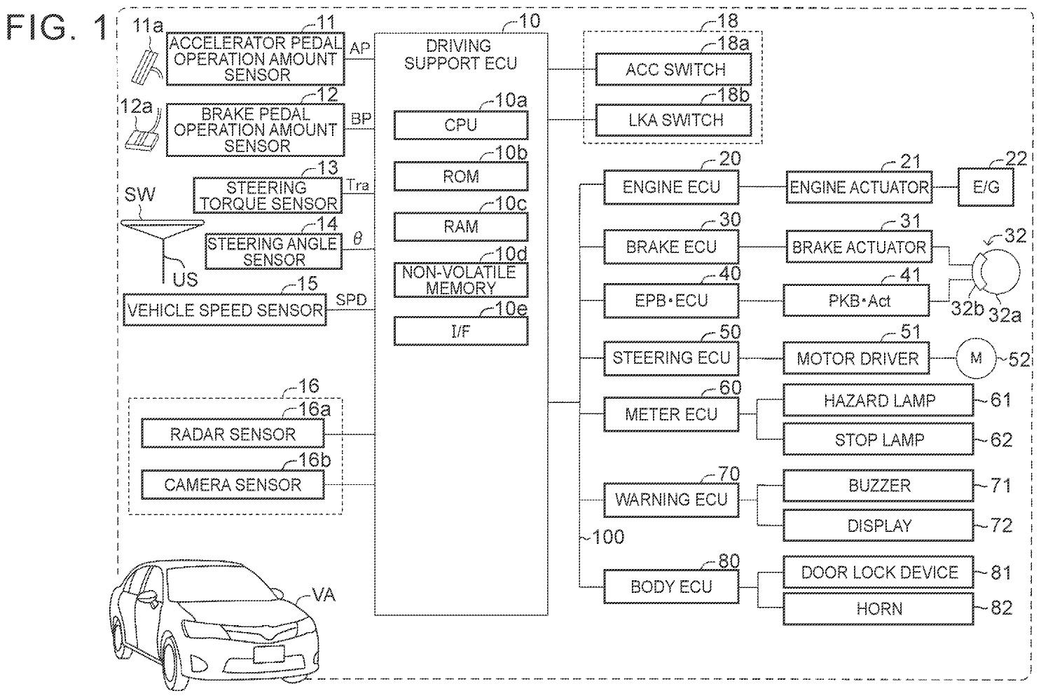

A vehicle control device according to the embodiment of the present disclosure is applied to a vehicle VA as shown in FIG. 1. The vehicle control device includes a driving support ECU 10, an engine ECU 20, a brake ECU 30, an electric parking brake ECU (hereinafter, referred to as an “EPB-ECU”) 40, a steering ECU 50, a meter ECU 60, a warning ECU 70, and a body ECU 80.

These ECUs are electric control units including a microcomputer as a main unit, and are connected to each other via a controller area network (CAN) 100 so that information can be transmitted and received. Some or all of the ECUs 10 to 80 may be integrated into one ECU.

In the present specification, a microcomputer includes a CPU, a ROM, a RAM, a non-volatile memory, an interface (I/F), and the like. The CPU realizes various functions by executing instructions (programs and routines) stored in ROM. For example, the driving support ECU 10 includes a microcomputer including a CPU 10a, a ROM 10b, a RAM 10c, a non-volatile memory 10d, an interface (I/F) 10e, and the like.

The driving support ECU 10 is connected to sensors and switches described later, and receives detection signals or output signals thereof.

An accelerator pedal operation amount sensor 11 detects an operation amount AP of an accelerator pedal 11a, and outputs a signal representing the accelerator pedal operation amount AP. A brake pedal operation amount sensor 12 detects an operation amount BP of a brake pedal 12a and outputs a signal indicating the brake pedal operation amount BP.

A steering torque sensor 13 detects a steering torque Tra acting on a steering shaft US by a driver's operation of a steering wheel SW (steering operation), and outputs a signal representing the steering torque Tra. A steering angle sensor 14 detects a steering angle θ of the vehicle VA and outputs a signal representing the steering angle θ. A vehicle speed sensor 15 detects a traveling speed (hereinafter, referred to as a “vehicle speed”) SPD of the vehicle VA, and outputs a signal representing the vehicle speed SPD.

Hereinafter, the accelerator pedal 11a, the brake pedal 12a, and the steering wheel SW may be collectively referred to as “driving control operators” because they are operators operated by the driver to drive the vehicle VA. Further, since the accelerator pedal operation amount sensor 11, the brake pedal operation amount sensor 12, and the steering torque sensor 13 are sensors that detect the operation amount of the driving operator, they may be collectively referred to as an “operation amount sensor”.

A surrounding sensor 16 is a sensor that detects the surrounding condition of the vehicle VA. The surrounding sensor 16 acquires information on a road around the vehicle VA (for example, a lane in which the vehicle VA is traveling) and information on a three-dimensional object existing on the road. A three-dimensional object includes, for example, moving objects such as pedestrians, four-wheeled vehicles and two-wheeled vehicles, and fixed objects such as guardrails, signs, and traffic lights. Hereinafter, these three-dimensional objects are simply referred to as “objects”. The surrounding sensor 16 includes a radar sensor 16a and a camera sensor 16b.

The radar sensor 16a includes a first radar sensor (front sensor) disposed at a front portion of a vehicle body and a second laser sensor (rear sensor) disposed at a rear portion of the vehicle body. The first radar sensor radiates, a radio wave of a millimeter wave band (hereinafter, referred to as a “millimeter wave”) to a front region of the vehicle VA, and the millimeter wave reflected by an object existing within the radiation range (that is, a reflected wave) is received. The second laser sensor radiates a millimeter wave to the rear region of the vehicle VA and receives the reflected wave. As a result, the radar sensor 16a determines whether the presence or absence of an object in the front region and the rear region of the vehicle VA, and calculates information indicating a relative relationship between the vehicle VA and the object. The information indicating the relative relationship between the vehicle and the object includes the distance between the vehicle VA and the object, the direction (or position) of the object with respect to the vehicle VA, the relative speed of the object with respect to the vehicle VA, and the like. The information obtained from the radar sensor 16a (including information indicating the relative relationship between the vehicle VA and the object) is referred to as “object information”.

The camera sensor 16b is disposed at the front portion of the vehicle body. The camera sensor 16b captures the scenery in the region in front of the vehicle VA and acquires image data. Based on the image data, the camera sensor 16b recognizes a plurality of division lines (for example, a left division line and a right division line) that define a lane in which the vehicle VA is traveling. Further, the camera sensor 16b calculates a parameter (for example, a curvature) indicating the shape of the lane, a parameter indicating the positional relationship between the vehicle VA and the lane, and the like. The parameter indicating the positional relationship between the vehicle VA and the lane includes, for example, the distance between the center position of the vehicle VA in a vehicle width direction and an arbitrary position on the left division line or the right division line. The information acquired by the camera sensor 16b is called “lane information”. The camera sensor 16b may be configured to determine the presence or absence of the object and calculate the object information based on the image data.

The surrounding sensor 16 outputs information on the surrounding conditions of the vehicle including “the object information and the lane information” to the driving support ECU 10 as “vehicle peripheral information”.

An operation switch 18 is provided on the steering wheel SW, and includes various switches operated by the driver when starting/ending the driving support control. The driving support control includes a follow-up inter-vehicle distance control and a lane keeping control.

The follow-up inter-vehicle distance control is well known (see, for example, Japanese Unexamined Patent Application Publication No. 2014-148293 (JP 2014-148293 A), Japanese Unexamined Patent Application Publication No. 2006-315491 (JP 2006-315491 A), and Japanese Patent No. 4172434 (JP 4172434 B), etc.) and may be referred to as an “adaptive cruise control”. Hereinafter, the follow-up inter-vehicle distance control is simply referred to as the “ACC”.

The lane keeping control is well known (see, for example, Japanese Unexamined Patent Application Publication No. 2008-195402 (JP 2008-195402 A), Japanese Unexamined Patent Application Publication No. 2009-190464 (JP 2009-190464 A), Japanese Unexamined Patent Application Publication No. 2010-6279 (JP 2010-6279 A), and Japanese Patent No. 4349210 (JP 4349210 B), etc.), and may be referred to as a “lane keeping assist” or a “lane tracing assist”. Hereinafter, a lane keeping control will be simply referred to as “LKA”.

The operation switch 18 includes an ACC switch 18a and an LKA switch 18b. The ACC switch 18a is a switch operated by the driver when starting/ending ACC. The LKA switch 18b is a switch operated by the driver when starting/ending LKA.

Further, the engine ECU 20 is connected to an engine actuator 21. The engine actuator 21 includes a throttle valve actuator that changes an opening degree of a throttle valve of an internal combustion engine 22. The engine ECU 20 can change the torque generated by the internal combustion engine 22 by driving the engine actuator 21. The torque generated by the internal combustion engine 22 is transmitted to drive wheels via a transmission (not shown). Thus, the engine ECU 20 can control the driving force of the vehicle VA and change the acceleration state (acceleration) by controlling the engine actuator 21.

When the vehicle VA is a hybrid vehicle, the engine ECU 20 can control the driving force generated by either or both of “an internal combustion engine and an electric motor” serving as a vehicle driving source. Further, when the vehicle VA is an electric vehicle, the engine ECU 20 can control the driving force generated by the electric motor serving as the vehicle driving source.

The brake ECU 30 is connected to a brake actuator 31. The brake actuator 31 is an actuator that controls a friction brake mechanism 32, and includes a known hydraulic circuit. The friction brake mechanism 32 includes a brake disc 32a fixed to a wheel and a brake caliper 32b fixed to a vehicle body. The brake actuator 31 adjusts the hydraulic pressure supplied to a wheel cylinder built in the brake caliper 32b in accordance with an instruction from the brake ECU 30, and presses a brake pad against the brake disc 32a with a hydraulic pressure to generate a friction braking force. Thus, the brake ECU 30 can control the braking force of the vehicle VA and change the acceleration state (deceleration, that is, negative acceleration) by controlling the brake actuator 31.

The EPB-ECU 40 is connected to a parking brake actuator (hereinafter, referred to as a “PKB-actuator”) 41. The PKB-actuator 41 presses the brake pad against the brake disc 32a, or, if equipped with a drum brake, presses a shoe against a drum that rotates with the wheels to generate frictional braking force. Thus, the EPB-ECU 40 can apply a parking brake force to the wheels by using the PKB-actuator 41 to keep the vehicle in a stopped state. Hereinafter, braking of the vehicle VA caused by operating the PKB-actuator 41 is simply referred to as an “EPB”.

The steering ECU 50 is a well-known control device for an electric power steering system, and is connected to a motor driver 51. The motor driver 51 is connected to a steering motor 52. The motor 52 is incorporated in a steering mechanism of the vehicle VA (including the steering wheel SW, the steering shaft US, a steering gear mechanism, and the like). The motor 52 generates torque by electric power supplied from the motor driver 51, and the steering assist torque can be applied or the left and right steered wheels can be steered by this torque.

The meter ECU 60 is connected to a digital display type meter (not shown) and is also connected to a hazard lamp 61 and a stop lamp 62. The meter ECU 60 can control the blinking of the hazard lamp 61 and the lighting of the stop lamp 62 in response to an instruction from the driving support ECU 10.

The warning ECU 70 is connected to a buzzer 71 and a display 72. The warning ECU 70 can sound the buzzer 71 to alert the driver or display an alert mark (warning lamp) on the display 72 in response to an instruction from the driving support ECU 10.

The body ECU 80 is connected to a door lock device 81 and a horn 82. The body ECU 80 can control the door lock device 81 in accordance with an instruction from the driving support ECU 10 to lock or unlock the door of the vehicle VA. Further, the body ECU 80 can make the horn 82 ring in response to an instruction from the driving support ECU 10.

Hereinafter, “the ACC and the LKA” executed by the driving support ECU 10 will be briefly described.

ACC

The ACC includes two types of control, which are a constant speed traveling control and a preceding vehicle following control. The constant speed traveling control is a control for making the vehicle VA travel so that a traveling speed of the vehicle VA matches a target speed (set speed) Vset without requiring the operation of the accelerator pedal 11a and the brake pedal 12a. The preceding vehicle following control is a control that makes the vehicle VA follow a following target vehicle while maintaining the inter-vehicle distance between a preceding vehicle (following target vehicle) and the vehicle VA at a target inter-vehicle distance Dset, without requiring the operation of the accelerator pedal 11a and the brake pedal 12a. The following target vehicle is a vehicle that is traveling in a front region of the vehicle VA and immediately in front of the vehicle VA.

When the ACC switch 18a is set to an ON state, the driving support ECU 10 determines whether there is the following target vehicle based on the object information included in the vehicle peripheral information. When the driving support ECU 10 determines that there is no following target vehicle, the driving support ECU 10 executes the constant speed traveling control. The driving support ECU 10 controls the engine actuator 21 by using the engine ECU 20 to control the driving force so that the vehicle speed SPD matches the target speed Vset, and controls the brake actuator 31 by using the brake ECU 30 to control the braking force when necessary.

In contrast, when the driving support ECU 10 determines that there is the following target vehicle, the driving support ECU 10 executes the preceding vehicle following control. The driving support ECU 10 calculates the target inter-vehicle distance Dset by multiplying a target inter-vehicle time tw by the vehicle speed SPD. The target inter-vehicle time tw is set by using an inter-vehicle time switch (not shown). The driving support ECU 10 controls the engine actuator 21 by using the engine ECU 20 to control the driving force so that the inter-vehicle distance between the vehicle VA and the following target vehicle matches the target inter-vehicle distance Dset, and controls the brake actuator 31 by using the brake ECU 30 to control the braking force when necessary.

LKA

The LKA is a control (steering control) that changes a steered angle of steered wheels of the vehicle VA so that the vehicle VA travels along a target traveling line set by utilizing the lane markings. The operation support ECU 10 executes the LKA when the LKA switch 18b is set to the ON state while the ACC switch 18a is in the ON state.

Specifically, the driving support ECU 10 acquires information about “the left division line and the right division line” of the lane in which the vehicle VA is traveling, based on the lane information included in the vehicle peripheral information. The driving support ECU 10 estimates the line connecting the center position in the width direction of the lane between the left division line and the right division line as a “lane center line LM”. The driving support ECU 10 sets the center line LM as a target traveling line TL.

The driving support ECU 10 calculates LKA control parameters required to execute the LKA. The LKA control parameters include a curvature CL of the target traveling line TL (=the reciprocal of a curvature radius R of the center line LM), a distance dL, a yaw angle θL, and the like. The distance dL is the distance between the target traveling line TL and the center position of the vehicle VA in the vehicle width direction (substantially in the road width direction). The yaw angle θL is the angle of a front-rear direction axis of the vehicle VA with respect to the target traveling line TL.

The driving support ECU 10 uses the LKA control parameters (CL, dL, θL) to calculate an automatic steering torque Trb for matching the position of the vehicle VA with the target traveling line TL in accordance with a known method. The automatic steering torque Trb is a torque applied to the steering mechanism by driving the motor 52 without the driver operating the steering wheel SW. The driving support ECU 10 controls the motor 52 via the motor driver 51 so that the actual torque applied to the steering mechanism matches the automatic steering torque Trb. That is, the driving support ECU 10 executes a steering control.

Overview of Vehicle Control when Driver is in Abnormal State

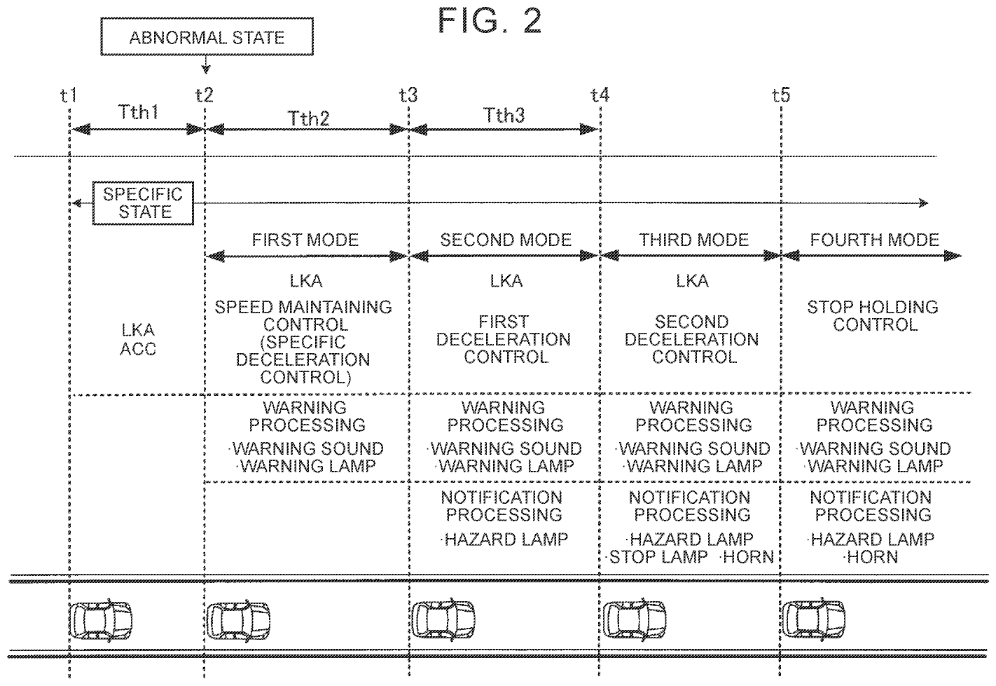

The driving support ECU 10 determines repeatedly whether the driver is in an “abnormal state in which they have lost the ability to drive the vehicle (hereinafter, simply referred to as an “abnormal state”)” when the ACC and the LKA are being executed. As described above, the abnormal state includes, for example, a dozing driving state, a mental and physical dysfunction state, and the like. The driving support ECU 10 executes a vehicle control in accordance with a plurality of driving modes when it is continuously determined that the driver is in an abnormal state. Hereinafter, the control of these plurality of operation modes will be described with reference to FIG. 2.

Normal Mode

In the example shown in FIG. 2, both the ACC and the LKA are normally executed before a time point t1. At the time point t1, the driving support ECU 10 detects that the driver is not operating the driving operator. Hereinafter, such a state will be referred to as a “specific state (or no operation state)”. The specific state is a state in which none of the parameters consisting of one or more combinations of “the accelerator pedal operation amount AP, the brake pedal operation amount BP, and the steering torque Tra” that change depending on the driving operation of the driver are changed. In this example, the driving support ECU 10 regards a state in which none of “the accelerator pedal operation amount AP, the brake pedal operation amount BP, and the steering torque Tra” are changed and the steering torque Tra remains “0” as a specific state.

The driving support ECU 10 continues the ACC and the LKA after the time point (t1) when the specific state is first detected. At the time point t1, a specific state was detected, but an abnormal state has not yet been detected. In this way, the operation mode in which both the ACC and the LKA are executed without the abnormal state being detected is referred to as a “normal mode”. In an initialization routine executed when the ACC and the LKA are started, the operation support ECU 10 sets the operation mode to the normal mode.

First Mode

A time point t2 is a time point at which a first time threshold value Tth1 has elapsed from the time point t1. When the specific state is continued for just the first time threshold value Tth1 from the time t1 when the specific state is first detected, the driving support ECU 10 determines that the driver is in the abnormal state. At t2 when it is determined that the driver is in the abnormal state, the driving support ECU 10 changes the driving mode from the normal mode to the first mode.

In the first mode, the driving support ECU 10 starts a warning control for the driver. Specifically, the driving support ECU 10 generates a warning sound from the buzzer 71 and displays a warning lamp on the display 72.

As described above, the conventional device only executes a warning control as a first stage processing (corresponding to the first mode of the present embodiment). When the driver is in the dozing state, the conventional device may not be able to waking up the driver since the conventional device can only stimulate the driver with a warning sound.

In the first mode, the driving support ECU 10 executes a control for temporarily decelerating the vehicle VA in addition to the warning control. Hereinafter, such a control will be referred to as a “specific deceleration control”. Specifically, the driving support ECU 10 executes the specific deceleration control at a predetermined timing during a period (a period of the first mode) from the time point t2 at which the control of the first mode is started to the time point at which the control of the second mode described later is started (t3 described later). The specific deceleration control is a control for temporarily decelerating the vehicle VA so as to give the driver a feeling of deceleration. Thus, when the driver is in a dozing state, the driving support ECU 10 can give a feeling of deceleration to the driver and wake up the driver earlier.

The feeling of acceleration (here, feeling of deceleration) felt by the driver will be described. It is conventionally known that the degree of acceleration felt by the driver can be evaluated by a stagnation time T and a stimulus intensity I (for example, see Japanese Unexamined Patent Application Publication No. 2017-089755 (JP 2017-089755 A), Japanese Unexamined Patent Application Publication No. 2017-129160 (JP 2017-129160 A), Japanese Unexamined Patent Application Publication No. 2020-075595 (JP 2017-129160 A), etc.). The stagnation time T is the time from the time point at which a factor that changes an acceleration G of the vehicle VA occurs until the driver feels that the acceleration G is starting to change. The stagnation time T includes a control delay time, a response time due to acceleration characteristics in accordance with a vehicle type or a vehicle class, and the like. The stimulus intensity I is a value determined by an amount of change ΔG of the acceleration that occurs immediately after the stagnation time T and a time change rate (jerk) J. The stimulus intensity I is, for example, the product of the amount of change ΔG of the acceleration G and the jerk J. The stimulus intensity I may be a value determined by at least one of the amount of change ΔG of the acceleration G and the jerk J. Hereinafter, the amount of change ΔG of the acceleration G and the jerk J are collectively referred to as “deceleration parameters”.

The specific deceleration control is a control for decelerating the vehicle VA over a deceleration time Tdi. The deceleration time Tdi is set so as to be longer than the stagnation time T and shorter than a predetermined upper limit time. The stagnation time T may change depending on the vehicle speed SPD (see JP 2017-089755 A). Thus, the driving support ECU 10 may set the deceleration time Tdi in accordance with the vehicle speed SPD. For example, the driving support ECU 10 may obtain the deceleration time Tdi by applying the vehicle speed SPD to a first map M1 (SPD) that defines the relationship between the vehicle speed SPD and the deceleration time Tdi.

In this example, the driving support ECU 10 sets a target deceleration parameter in advance so that the deceleration feeling felt by the driver becomes larger than a predetermined degree. The target deceleration parameter includes a target value ΔGtgt of the amount of change ΔG of the acceleration G and a target value Jtgt of the jerk J. For example, the target value ΔGtgt is set to a first amount of change ΔG1, and the target value Jtgt is set to a first jerk J1. The driving support ECU 10 controls the brake actuator 31 by using the brake ECU 30 so that the deceleration parameters (ΔG and J) immediately after the stagnation time T match the target deceleration parameters (ΔGtgt and Jtgt), respectively.

Hereinafter, the vehicle VA may be referred to as the “own vehicle VA” in order to distinguish it from other vehicles. Further, “another vehicle behind the own vehicle VA” means a vehicle (that is, a following vehicle) that is traveling behind the own vehicle VA and that is traveling in the same lane as the own vehicle VA.

Suppose there is another vehicle behind the own vehicle VA. In such a situation, when the own vehicle VA is temporarily decelerated, there is a possibility that the other vehicle approaches the own vehicle VA. In consideration of this, the driving support ECU 10 determines whether there is the other vehicle behind the own vehicle VA, based on the object information (information about the object that is in the rear region of the own vehicle VA) acquired from the second laser sensor of the radar sensor 16a. When there is no other vehicle behind the own vehicle VA, the driving support ECU 10 executes the specific deceleration control.

In contrast, when there is the other vehicle behind the own vehicle VA, the driving support ECU 10 executes a speed maintaining control for maintaining the current vehicle speed SPD of the own vehicle VA. Since the vehicle VA is not decelerated, it is possible to prevent the own vehicle VA from approaching another vehicle.

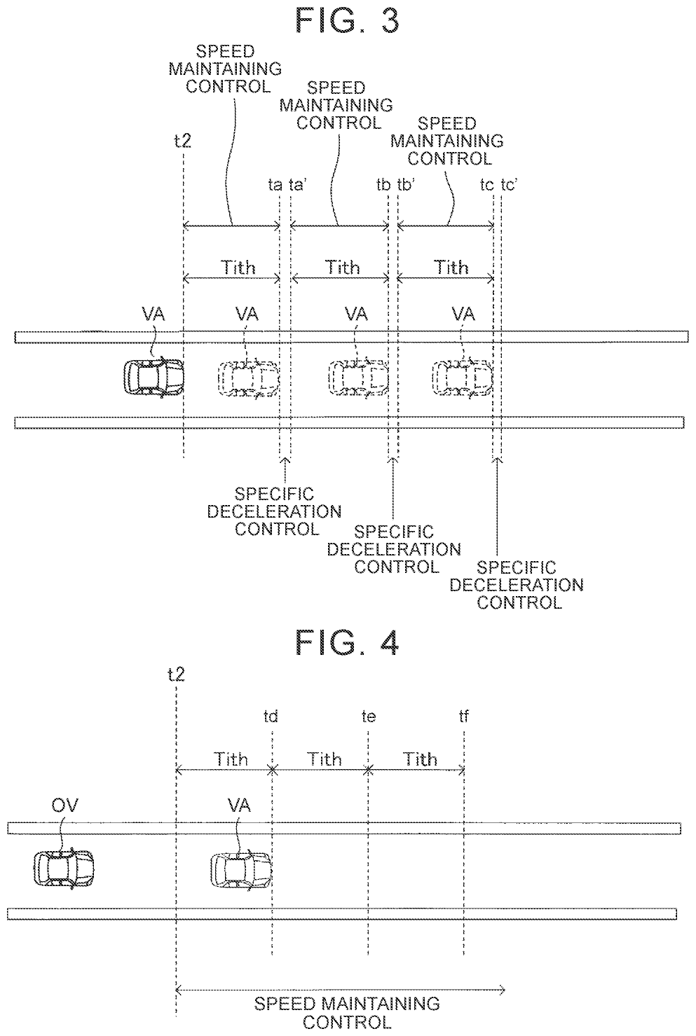

Hereinafter, the control in the first mode will be described with reference to FIGS. 3 and 4. In the example in FIG. 3, at the time point t2, the operation support ECU 10 changes the operation mode from the normal mode to the first mode. In this example, there is no other vehicle behind the own vehicle VA. The driving support ECU 10 first executes the speed maintaining control.

Next, at a time point ta at which the predetermined time threshold value Tith elapses from the time point t2, the driving support ECU 10 determines whether there is the other vehicle behind the own vehicle VA. Since there is no other vehicle behind the own vehicle VA, the driving support ECU 10 executes the specific deceleration control in the period from the time point ta to a time point ta′ (corresponding to the deceleration time Tdi).

The driving support ECU 10 executes the speed maintaining control from the time ta′ when the specific deceleration control is ended. That is, the driving support ECU 10 executes the speed maintaining control so as to maintain the vehicle speed SPD at the time point ta′. At a time point tb at which the time threshold value Tith has elapsed from the time point ta′, the driving support ECU 10 determines whether there is the other vehicle behind the own vehicle VA. Since there is no other vehicle behind the own vehicle VA, the driving support ECU 10 executes the specific deceleration control in the period from the time point tb to a time point tb′ (corresponding to the deceleration time Tdi).

The driving support ECU 10 executes the speed maintaining control from the time tb′ at which the specific deceleration control is completed. That is, the driving support ECU 10 executes the speed maintaining control so as to maintain the vehicle speed SPD at the time point tb′. At a time point tc at which the time threshold value Tith has elapsed from the time point tb′, the driving support ECU 10 determines whether there is the other vehicle behind the own vehicle VA. Since there is no other vehicle behind the own vehicle VA, the driving support ECU 10 executes the specific deceleration control in the period from the time point tc to a time point tc′ (corresponding to the deceleration time Tdi).

The driving support ECU 10 executes the speed maintaining control from the time tc′ at which the specific deceleration control is ended. That is, the driving support ECU 10 executes the speed maintaining control so as to maintain the vehicle speed SPD at the time point tc′.

In this way, the driving support ECU 10 determines whether there is the other vehicle behind the own vehicle VA each time the time threshold value Tith elapses. Then, when there is no other vehicle behind the own vehicle VA, the driving support ECU 10 executes the specific deceleration control.

In the example in FIG. 4, at the time point t2, the operation support ECU 10 changes the operation mode from the normal mode to the first mode. In this example, there is another vehicle OV behind the own vehicle VA. The driving support ECU 10 first executes the speed maintaining control.

Next, at a time point td at which the time threshold value Tith elapses from the time point t2, the driving support ECU 10 determines whether there is the other vehicle behind the own vehicle VA. The driving support ECU 10 determines that there is the other vehicle OV behind the own vehicle VA, and continues the speed maintaining control.

Thereafter, the driving support ECU 10 determines whether there is the other vehicle behind the own vehicle VA each time the time threshold value Tith elapses. That is, the driving support ECU 10 determines whether there is the other vehicle behind the own vehicle VA at a time point to and a time point tf. Since there is the other vehicle OV behind the own vehicle VA, the driving support ECU 10 continues the speed maintaining control.

When the driver notices the above warning control and restarts the driving operation, one or more of the parameters (AP, BP, and Tra) of the driving operator is changed. In this case, the driving support ECU 10 determines that the driver's state has returned from the abnormal state to the normal state. Thus, the driving support ECU 10 changes the driving mode from the first mode to the normal mode. As a result, the driving support ECU 10 ends the warning control. Then, as described above, the driving support ECU 10 restarts either the constant speed traveling control or the preceding vehicle following control depending on the presence or absence of the following vehicle.

Second Mode

Returning to the description of FIG. 2. The time point t3 is a time point at which a second time threshold value Tth2 has elapsed from the time point t2. When the specific state continues for just the second time threshold value Tth2 from the time point t2 when the abnormal state is first detected (that is, at the time point t3), the operation support ECU 10 changes the operation mode from the first mode to the second mode.

In the second mode, the driving support ECU 10 executes the first deceleration control. Specifically, the driving support ECU 10 sets the target deceleration Gtgt to a first deceleration (negative acceleration) al, and controls the brake actuator 31 by using the brake ECU 30 so that the acceleration of the vehicle VA matches the target deceleration Gtgt. The driving support ECU 10 continues the LKA.

The driving support ECU 10 continues the warning control even after the time point t3. The driving support ECU 10 may change the volume and/or generation interval of the warning sound of the buzzer 71 after the time point t3. Further, the driving support ECU 10 may set an audio device (not shown) from an on state to an off state. This makes it easier for the driver to notice the warning sound of the buzzer 71.

Further, the driving support ECU 10 executes a notification control for other vehicles, pedestrians, etc. around the vehicle VA after the time point t3. Specifically, the driving support ECU 10 outputs a blinking command of the hazard lamp 61 to the meter ECU 60 so as to make the hazard lamp 61 blink.

When the driver notices the above warning control and restarts the driving operation, the driving support ECU 10 changes the driving mode from the second mode to the normal mode. As a result, the driving support ECU 10 ends the first deceleration control, the warning control, and the notification control. Then, as described above, the driving support ECU 10 restarts either the constant speed traveling control or the preceding vehicle following control depending on the presence or absence of the following vehicle.

Third Mode

A time point t4 is a time point at which a third time threshold value Tth3 has elapsed from the time point t3. In this way, when the specific state continues from the time point t3 for just a third time threshold value Tth3 (that is, at the time point t4), the operation support ECU 10 changes the operation mode from the second mode to the third mode.

In the third mode, the driving support ECU 10 executes the second deceleration control instead of the first deceleration control. Specifically, the driving support ECU 10 sets the target deceleration Gtgt to a second deceleration (negative acceleration) α2, and controls the brake actuator 31 by using the brake ECU 30 so that the acceleration of the vehicle VA matches the target deceleration Gtgt. The driving support ECU 10 continues the LKA. The magnitude (absolute value) of the second deceleration α2 is larger than the magnitude of the first deceleration al. As a result, the driving support ECU 10 decelerates the vehicle VA and forcibly stops the vehicle VA. The driving support ECU 10 continues the LKA until the vehicle VA stops.

Even after the time point t4, the driving support ECU 10 continues the warning control and the notification control. In the notification control, the driving support ECU 10 executes the following additional processes. The operation support ECU 10 outputs a lighting command for the stop lamp 62 to the meter ECU 60 to light the stop lamp 62. In addition, the driving support ECU 10 outputs a ringing command of the horn 82 to the body ECU 80 to ring the horn 82.

When the driver notices the above warning control and restarts the driving operation, the driving support ECU 10 changes the driving mode from the third mode to the normal mode. As a result, the driving support ECU 10 ends the second deceleration control, the warning control, and the notification control. Then, the driving support ECU 10 restarts either the constant speed traveling control or the preceding vehicle following control depending on the presence or absence of the following target vehicle.

Hereinafter, as described above, a “control to decelerate the vehicle VA to stop the vehicle VA (the first deceleration control in the second mode and the second deceleration control in the third mode)” may be collectively referred to as a “stop control”.

Fourth Mode

A time point t5 is a time point at which the vehicle VA is stopped by the second deceleration control. At the time point t5, the operation support ECU 10 changes the operation mode from the third mode to a fourth mode. The driving support ECU 10 ends the LKA. Further, the driving support ECU 10 ends the second deceleration control. In addition, the driving support ECU 10 outputs a door lock release command to the body ECU 80, and causes the door lock device 81 to release the door lock.

In the fourth mode, the driving support ECU 10 executes stop holding control. The stop holding control is a control for holding the vehicle VA in a stopped state by continuously applying a braking force to the vehicle VA with the EPB.

The driving support ECU 10 continues the warning control and the notification control even after the time point t5. In the notification control, the driving support ECU 10 ends lighting of the stop lamp 62, and continues only blinking of the hazard lamp 61 and ringing of the horn 82.

The operation support ECU 10 releases the stop holding control when a predetermined release operation is performed while the stop holding control is being executed. In this example, the release operation is a pressing operation of the LKA switch 18b. The release operation is not limited to this. The release operation may be an operation of pressing the LKA switch 18b in a state in which a shift lever (not shown) is moved to a parking position (P). A button (not shown) for the release operation may be provided near the driver's seat. The release operation may be an operation of pressing the button.

Operation

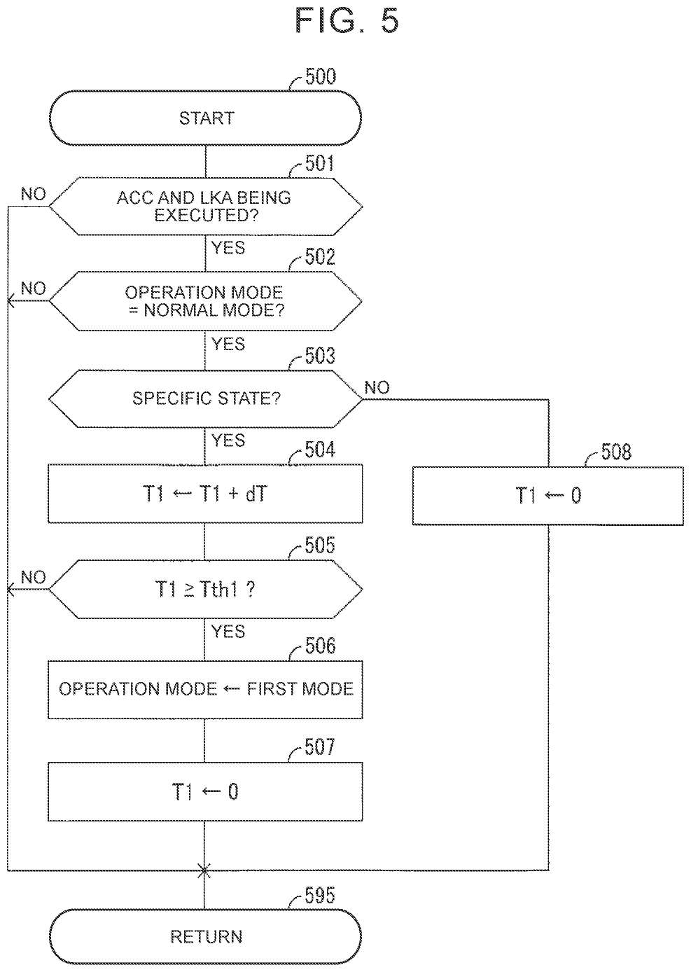

A CPU of the operation support ECU 10 (hereinafter, simply referred to as a “CPU”) executes each of the routines shown in FIGS. 5 and 6 and FIGS. 8 to 10 every time a predetermined time dT elapses.

The CPU receives detection signals or output signals from the sensors 11 to 16 and the various switches 18a and 18b each time the predetermined time dT elapses and stores the signals in the RAM.

At a predetermined timing, the CPU starts processing from step 500 of the routine in FIG. 5 and proceeds to step 501 to determine whether the ACC and the LKA are currently being executed. If the ACC and the LKA are not executed at this time, it is determined as “No” in step 501, the process directly proceeds to step 595, and this routine is temporarily ended.

When the ACC and the LKA are currently being executed, the CPU determines “Yes” in step 501 and proceeds to step 502 to determine whether the operation mode is the normal mode. If the operation mode is not the normal mode, the CPU determines “No” in step 502, directly proceeds to step 595, and temporarily ends this routine.

Assuming that the ACC and the LKA have just started, the operating mode is the normal mode. In this case, the CPU determines “Yes” in step 502, proceeds to step 503, and determines whether a specific state is detected based on the detection signals of various sensors (11, 12 and 13). As described above, when none of “the accelerator pedal operation amount AP, the brake pedal operation amount BP, and the steering torque Tra” are changed and the steering torque Tra remains “0”, the CPU detects the specific state.

When the specific state is detected, the CPU determines “Yes” in step 503, proceeds to step 504, and increases a first duration T1 by the predetermined time dT. The first duration T1 represents the time during which the specific state is continued. As described above, the predetermined time dT is the time corresponding to an execution cycle of the routine in FIG. 5. The first duration T1 is set to “0” in the initialization routine described above.

Next, when proceeding to step 505, the CPU determines whether the first duration time T1 is equal to or greater than the first time threshold value Tth1. Assuming that the current time point is a time point immediately after the specific state is first detected, the first duration T1 is smaller than the first time threshold Tth1. The CPU determines “No” in step 505, proceeds to step 595, and temporarily ends this routine.

In contrast, when the first duration T1 becomes equal to or higher than the first time threshold Tth1 because the specific state is continued, the CPU determines “Yes” in step 505, and sequentially performs steps 506 and 507 that are described below. Thereafter, the CPU proceeds to step 595 and temporarily ends this routine.

Step 506: The CPU determines that the driver's state is the abnormal state, and sets the operation mode to the first mode. Step 507: The CPU resets the first duration T1 to “0”.

If the CPU determines “No” in step 503, the CPU proceeds to step 508, resets the first duration T1 to “0”, and then directly proceeds to step 595 to temporarily end this routine.

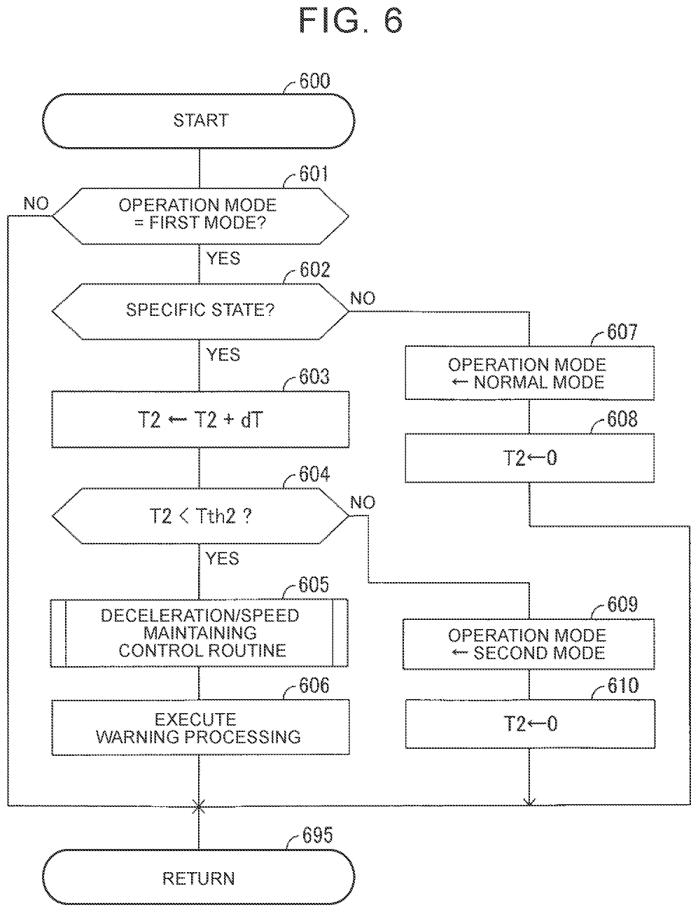

Further, at a predetermined timing, the CPU starts the process from step 600 of the routine in FIG. 6 and proceeds to step 601 to determine whether the operation mode is the first mode. If the operation mode is not the first mode, the CPU determines “No” in step 601 and directly proceeds to step 695 to temporarily end this routine.

In contrast, since it is determined that the driver's state is the abnormal state, it is assumed that the current operation mode is the first mode. In this case, the CPU determines “Yes” in step 601 and proceeds to step 602.

In step 602, the CPU determines whether the specific state has been detected. When the specific state is detected, the CPU determines “Yes” in step 602, proceeds to step 603, and increases a second duration T2 by the predetermined time dT. The second duration T2 represents the time during which the specific state is continued from the time when the control of the first mode is shifted (that is, the time point at which the process of step 506 is executed). In other words, the second duration T2 represents the time during which the abnormal state is continued from the time when the driver is first determined to be in the abnormal state. The second duration T2 is set to “0” in the initialization routine described above.

Next, when the CPU proceeds to step 604, it determines whether the second duration T2 is less than the second time threshold Tth2. Immediately after the operation mode shifts to the first mode, the second duration T2 is smaller than the second time threshold Tth2. Thus, the CPU determines “Yes” in step 604, and sequentially performs the processes of steps 605 and 606 described below. Thereafter, the CPU proceeds to step 695 and temporarily ends this routine.

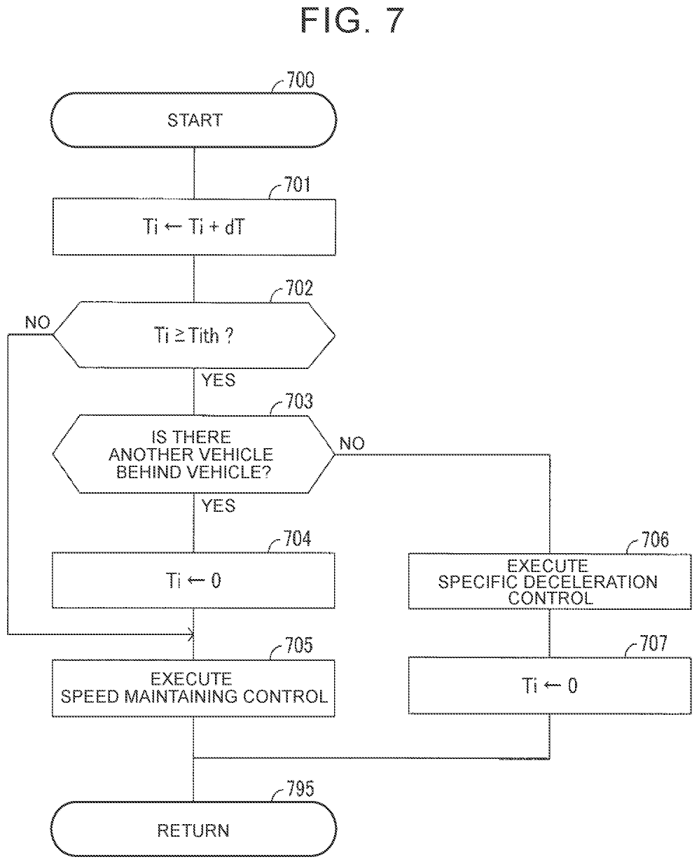

Step 605: The CPU executes the routine in FIG. 7, which will be described later.

Step 606: The CPU executes the warning control as described above. Specifically, the CPU generates a warning sound from the buzzer 71 and displays a warning lamp on the display 72.

Suppose the driver resumes the driving operation. In this situation, when the CPU proceeds to step 602, the CPU determines “No” in step 602 and sequentially performs the processes of step 607 and step 608 described below. Thereafter, the CPU proceeds to step 695 and temporarily ends this routine.

Step 607: The CPU sets the operation mode to the normal mode. As a result, since the CPU determines “No” in step 601, the warning control is ended. Then, the CPU restarts either the constant speed traveling control or the preceding vehicle following control depending on the presence or absence of the following target vehicle.
Step 608: The CPU resets the second duration T2 to “0”. Further, the CPU resets the time Ti described later to “0”.

In contrast, suppose the second duration T2 becomes equal to or higher than the second time threshold Tth2 because the specific state is continued. In this case, the CPU determines “No” in step 604, and sequentially performs the processes of step 609 and step 610 described below. Thereafter, the CPU proceeds to step 695 and temporarily ends this routine.

Step 609: The CPU sets the operation mode to the second mode.
Step 610: The CPU resets the second duration T2 to “0”. Further, the CPU resets the time Ti described later to “0”.

When the CPU proceeds to step 605 of the routine of in FIG. 6, the CPU starts processing from step 700 of the routine in FIG. 7 and proceeds to step 701 to increase the time Ti by the predetermined time dT. The time Ti is a variable for determining the timing for executing step 703, which will be described later. The time Ti is set to “0” in the initialization routine described above.

Next, the CPU proceeds to step 702 and determines whether the time Ti is equal to or greater than the time threshold Tith. Assuming that the present time is the time immediately after the operation mode shifts to the first mode, the time Ti is smaller than the time threshold Tith. In this case, the CPU determines “No” in step 702, proceeds to step 705, and executes the speed maintaining control as described above. Thereafter, the CPU proceeds to step 795, and proceeds from step 605 to step 606 of the routine in FIG. 6.

In contrast, when the time Ti becomes equal to or more than the time threshold value Tith, the CPU determines “Yes” in step 702 and proceeds to step 703 to determine whether there is the other vehicle behind the own vehicle VA. When there is the other vehicle behind the own vehicle VA, the CPU determines “Yes” in step 703, and sequentially performs the processes of steps 704 and 705 described below. Thereafter, the CPU proceeds to step 795, and proceeds from step 605 to step 606 of the routine in FIG. 6.

Step 704: The CPU resets the time Ti to “0”.

Step 705: The CPU executes the speed maintaining control as described above.

In contrast, when there is no other vehicle behind the own vehicle VA, the CPU determines “No” in step 703 and sequentially performs the processes of step 706 and step 707 described below. Thereafter, the CPU proceeds to step 795, and proceeds from step 605 to step 606 of the routine in FIG. 6.

Step 706: The CPU executes the specific deceleration control as described above. As a result, the vehicle VA is temporarily decelerated.

Step 707: The CPU resets the time Ti to “0”.

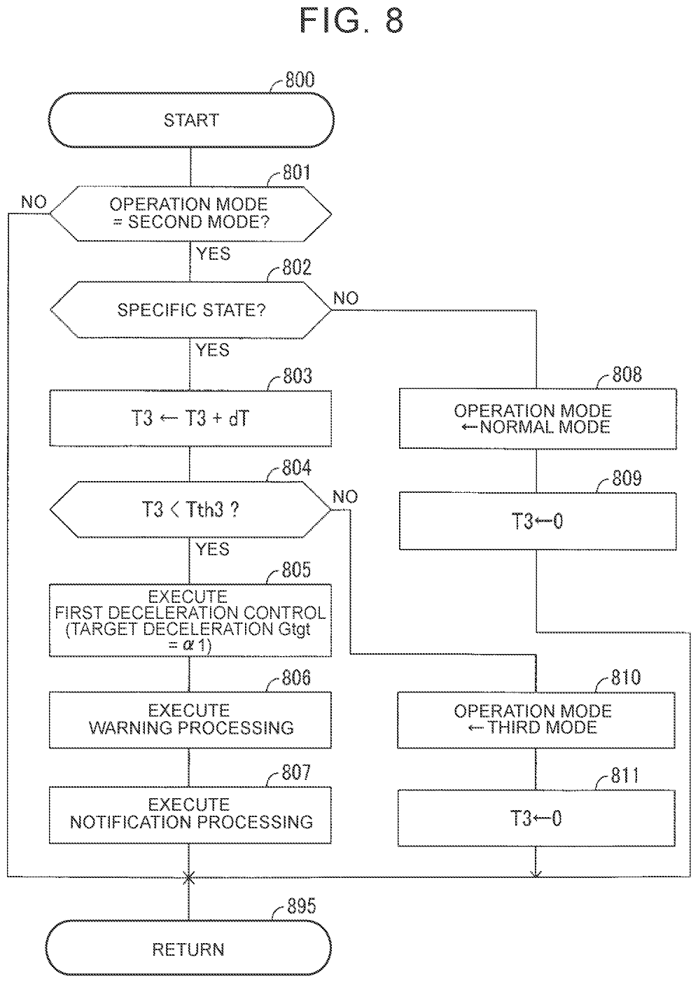

Further, at a predetermined timing, the CPU starts the process from step 800 of the routine in FIG. 8 and proceeds to step 801 to determine whether the operation mode is the second mode. If the operation mode is not the second mode, the CPU determines “No” in step 801 and directly proceeds to step 895 to temporarily end this routine.

In contrast, when the operation mode is the second mode, the CPU determines “Yes” in step 801 and proceeds to step 802 to determine whether the specific state has been detected. When the specific state is detected, the CPU determines “Yes” in step 802, proceeds to step 803, and increases the third duration T3 by the predetermined time dT. The third duration T3 represents the time during which the specific state is continued from the time point at which the control of the second mode is shifted (that is, the time point at which the process of step 609 is executed). In other words, the third duration T3 represents the time during which the abnormal state is continued from the time point at which the control of the second mode is shifted. The third duration T3 is set to “0” in the initialization routine described above.

Next, when the CPU proceeds to step 804, the CPU determines whether the third duration T3 is less than the third time threshold Tth3. Immediately after the operation mode shifts to the second mode, the third duration T3 is smaller than the third time threshold Tth3. Thus, the CPU determines “Yes” in step 804, and sequentially performs the processes of steps 805 to 807 described below. Thereafter, the CPU proceeds to step 895 and temporarily ends this routine.

Step 805: The CPU executes the first deceleration control as described above. Specifically, the CPU controls the brake actuator 31 by using the brake ECU 30 so that the acceleration of the vehicle VA matches the target deceleration Gtgt (=first deceleration α1).

Step 806: The CPU executes the warning control as described above. Specifically, the CPU generates a warning sound from the buzzer 71 and displays a warning lamp on the display 72.
Step 807: The CPU executes the notification control as described above. Specifically, the CPU blinks the hazard lamp 61.

Suppose the driver resumes the driving operation. In this situation, when the CPU proceeds to step 802, the CPU determines “No” in the step 802, and sequentially performs the processes of step 808 and step 809 described below. Thereafter, the CPU proceeds to step 895 and temporarily ends this routine.

Step 808: The CPU sets the operation mode to the normal mode. As a result, since the CPU determines “No” in step 801, the first deceleration control, the warning control, and the notification control are ended. Then, the CPU restarts either the constant speed traveling control or the preceding vehicle following control depending on the presence or absence of the following target vehicle.

Step 809: The third duration T3 is reset to “0”.

In contrast, suppose the third duration T3 becomes equal to or higher than the third time threshold Tth3 because the specific state is continued. In this case, the CPU determines “No” in step 804, and sequentially performs the processes of step 810 and step 811 described below. Thereafter, the CPU proceeds to step 895 and temporarily ends this routine.

Step 810: The CPU sets the operation mode to the third mode.

Step 811: The third duration T3 is reset to “0”.

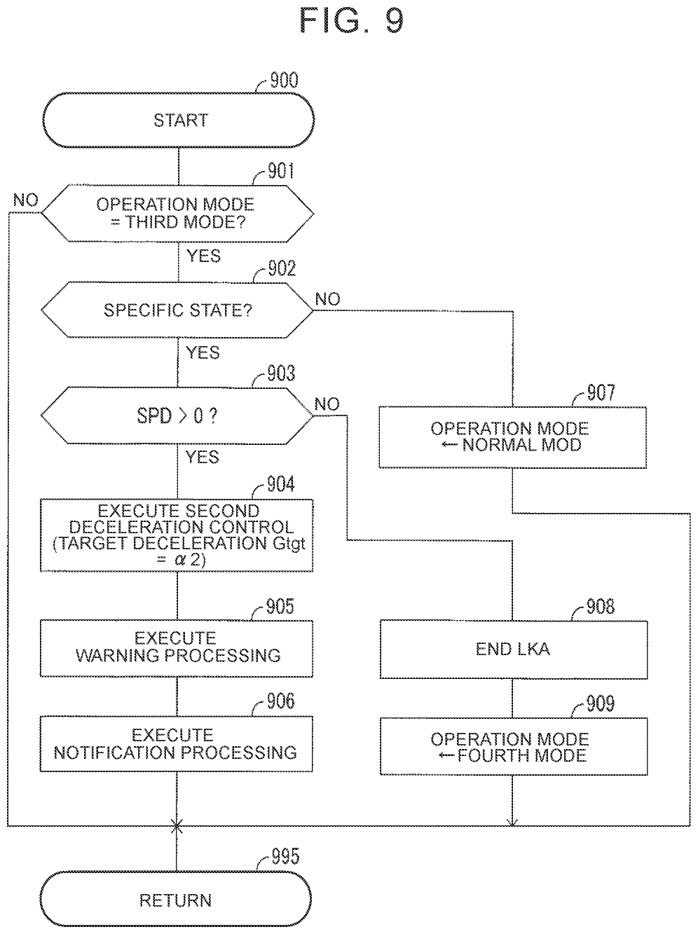

Further, at a predetermined timing, the CPU starts the process from step 900 of the routine in FIG. 9 and proceeds to step 901 to determine whether the operation mode is the third mode. If the operation mode is not the third mode, the CPU determines “No” in step 901 and directly proceeds to step 995 to temporarily end this routine.

In contrast, when the operation mode is the third mode, the CPU determines “Yes” in step 901 and proceeds to step 902 to determine whether the specific state has been detected. When the specific state is detected, the CPU determines “Yes” in step 902, proceeds to step 903, and determines whether the vehicle speed SPD is greater than “0”. When the vehicle VA has not stopped yet, the CPU determines “Yes” in step 903, and sequentially performs the processes of steps 904 to 906 described below. Thereafter, the CPU proceeds to step 995 and temporarily ends this routine.

Step 904: The CPU executes the second deceleration control as described above. Specifically, the CPU controls the brake actuator 31 by using the brake ECU 30 so that the acceleration of the vehicle VA matches the target deceleration Gtgt (=second deceleration α2).

Step 905: The CPU executes the warning control as described above.
Step 906 The CPU executes the notification control as described above. Specifically, the CPU blinks the hazard lamp 61. Further, the CPU turns on the stop lamp 62 and sounds the horn 82.

Suppose the driver resumes the driving operation. In this situation, when the CPU proceeds to step 902, the CPU determines “No” in step 902, proceeds to step 907, and sets the operation mode to the normal mode. As a result, since the CPU determines “No” in step 901, the second deceleration control, the warning control, and the notification control are ended. Then, the CPU restarts either the constant speed traveling control or the preceding vehicle following control depending on the presence or absence of the following target vehicle.

In contrast, suppose the vehicle VA has stopped due to the CPU repeatedly executing the processes of steps 904 to 906. In this case, the CPU determines “No” in step 903, and sequentially performs the processes of step 908 and step 909 described below. Thereafter, the CPU proceeds to step 995 and temporarily ends this routine.

Step 908: The CPU terminates the LKA.

Step 909: The CPU sets the operation mode to the fourth mode. At this point, the CPU controls the door lock device 81 to release the door lock of the vehicle VA.

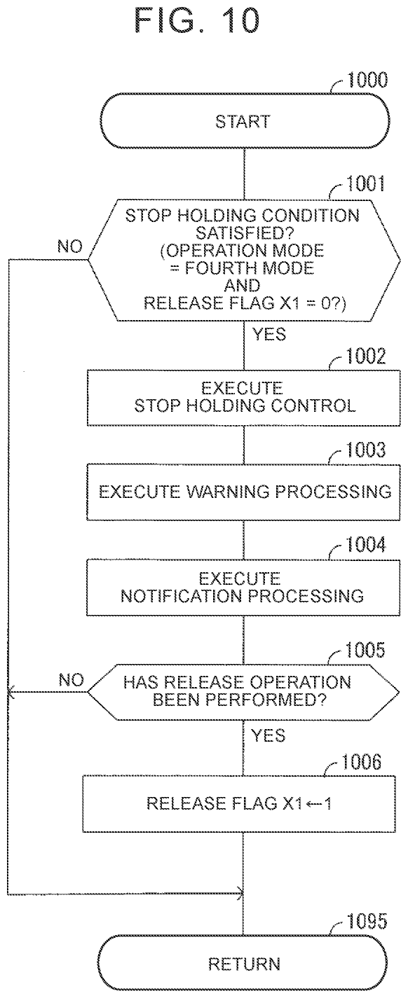

Further, at a predetermined timing, the CPU starts the process from step 1000 of the routine in FIG. 10 and proceeds to step 1001 to determine whether the predetermined stop holding condition is satisfied. The stop holding condition is satisfied when the operation mode is the fourth mode and the value of a release flag X1 is “0”. The release flag X1 is a flag indicating whether to release the stop holding control, and is set to “1” when the stop holding control is released/ended, as will be described later. The release flag X1 is set to “0” in the initialization routine described above.

If the stop holding condition is not satisfied, the CPU determines “No” in step 1001, proceeds directly to step 1095, and temporarily ends this routine.

In contrast, immediately after the operation mode shifts to the fourth mode, the stop holding condition is satisfied. In this case, the CPU determines “Yes” in step 1001 and sequentially performs the processes of steps 1002 to 1004 described below. Thereafter, the CPU proceeds to step 1005.

Step 1002: The CPU executes the stop holding control as described above.

Step 1003: The CPU executes the warning control as described above.
Step 1004: The CPU executes the notification control as described above. Specifically, the CPU blinks the hazard lamp 61 and sounds the horn 82.

When the CPU proceeds to step 1005, the CPU determines whether the predetermined release operation has been performed. When the release operation has not been performed, the CPU determines “No” in step 1005, proceeds to step 1095, and temporarily ends this routine. Since the value of the release flag X1 is maintained at “0”, the stop holding control, the warning control, and the notification control are continued.

In contrast, when the release operation is performed, the CPU determines “Yes” in step 1005, proceeds to step 1006, and sets the value of the release flag X1 to “1”. Thereafter, the CPU proceeds to step 1095 and temporarily ends this routine. As a result, the CPU determines “No” in step 1001. Thus, the CPU ends the stop holding control and also ends the warning control and the notification control. After the stop holding control is completed, the driver can drive the vehicle VA by their own driving operation.

When the driver wants to restart the ACC and the LKA after the stop holding control is ended, the driver operates the ACC switch 18a and the LKA switch 18b. In response to this operation, the CPU sets the operation mode to the normal mode and restarts the ACC and the LKA.

The vehicle control device having the above configuration determines whether there is the other vehicle behind the own vehicle VA during the execution of the control of the first mode (in the period from the time point t2 to the time point t3 in FIG. 2). When the vehicle control device determines that there is no other vehicle behind the own vehicle VA, the vehicle control device executes specific deceleration control. When the driver is in the dozing state, the vehicle control device can give the driver a feeling of deceleration and awaken the driver faster than the conventional device.

In contrast, the vehicle control device executes the speed maintaining control when it is determined that there is the other vehicle behind the own vehicle VA. Since the vehicle VA is not decelerated, it is possible to prevent the own vehicle VA from approaching another vehicle.

Further, the vehicle control device determines whether there is the other vehicle behind the own vehicle VA each time the predetermined time threshold value Tith elapses, and when the vehicle control device determines that there is no other vehicle behind the own vehicle VA, the vehicle control device executes specific deceleration control. The vehicle control device can increase the possibility of awakening the driver by repeatedly giving the driver a feeling of deceleration.

The present disclosure is not limited to the above embodiment, and various modifications can be adopted within the scope of the present disclosure.

### First Modification

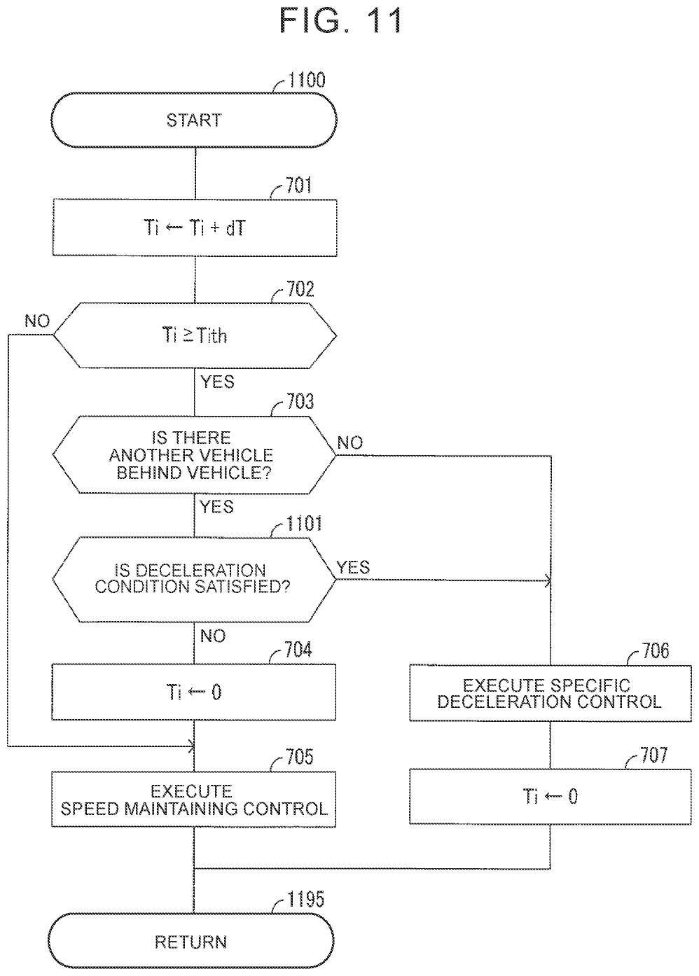

In step 605 of the routine in FIG. 6, the CPU may execute the routine in FIG. 11 in place of the routine in FIG. 7. The routine in FIG. 11 is a routine in which step 1101 is added to the routine in FIG. 7. Thus, among the steps shown in FIG. 11, the description of the steps having the same reference numerals as those in FIG. 7 will be omitted.

When the CPU proceeds to step 605 of the routine in FIG. 6, the CPU starts the processing from step 1100 of the routine in FIG. 11. When the CPU determines “Yes” in step 703 and proceeds to step 1101, the CPU determines whether the predetermined deceleration condition is satisfied. The deceleration condition is a condition that is satisfied when the possibility that the own vehicle VA approaches the other vehicle OV is low by the specific deceleration control. In this example, the deceleration condition is satisfied when an inter-vehicle distance Din between the own vehicle VA and the other vehicle OV is equal to or greater than a predetermined distance threshold Dth. As described above, when the inter-vehicle distance Din is relatively large, it is unlikely that the own vehicle VA approaches the other vehicle OV even if the specific deceleration control is executed. When the deceleration condition is satisfied, the CPU determines “Yes” in step 1101 and sequentially executes the processes of step 706 and step 707 as described above. That is, the CPU executes the specific deceleration control.

In contrast, when the deceleration condition is not satisfied, the CPU determines “No” in step 1101 and sequentially executes the processes of steps 704 and 705 as described above. That is, the CPU executes the speed maintaining control.

The deceleration condition is not limited to the above example. The CPU may determine whether the deceleration condition is satisfied by using one or both of the inter-vehicle distance Din between the own vehicle VA and the other vehicle OV and the relative speed Vre of the other vehicle OV with respect to the own vehicle VA. For example, the deceleration condition may be a condition that is satisfied when the relative speed Vre of the other vehicle OV with respect to the own vehicle VA is equal to or less than a predetermined positive relative speed threshold value Vrth. In another example, the deceleration condition may be a condition that is satisfied when a predicted time Tk until the other vehicle OV reaches the own vehicle VA is equal to or greater than a predetermined time threshold value Tkth. This estimated time Tk may be referred to as a time to collision (TTC). The predicted time Tk is calculated by dividing the inter-vehicle distance Din by the relative speed Vre.

### Second Modification

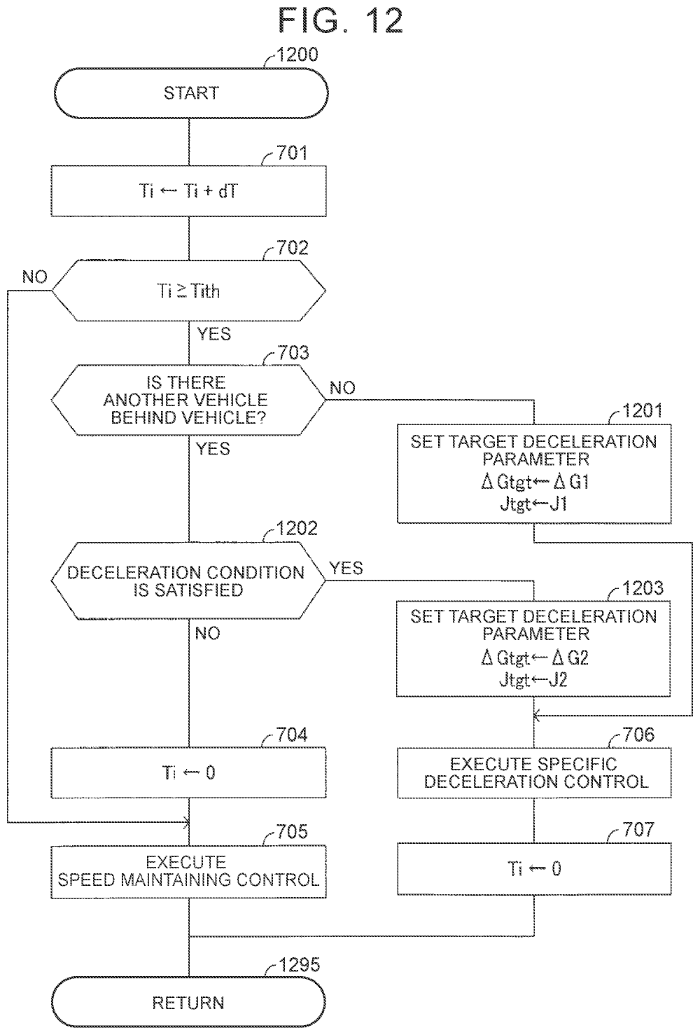

In step 605 of the routine in FIG. 6, the CPU may execute the routine in FIG. 12 in place of the routine in FIG. 7. The routine in FIG. 12 is a routine in which step 1201 and step 1203 is added to the routine in FIG. 7. Thus, among the steps shown in FIG. 12, the description of the steps having the same reference numerals as those in FIG. 7 will be omitted.

When the CPU proceeds to step 605 of the routine in FIG. 6, the CPU starts the processing from step 1200 of the routine in FIG. 12. When the CPU determines “No” in step 703 and proceeds to step 1201, the CPU sets the target deceleration parameters (ΔGtgt and Jtgt). The CPU sets the target value ΔGtgt of the amount of change ΔG of the acceleration G to the first amount of change ΔG1 and sets the target value Jtgt of the jerk J to the first jerk J1. Thereafter, in step 706, the CPU controls the brake actuator 31 using the brake ECU 30 so that the deceleration parameters (here, ΔG and J) immediately after the stagnation time T match the target deceleration parameters (here, ΔG1 and J1), respectively.

When the CPU determines “Yes” in step 703 and proceeds to step 1202, it is determined whether the above-mentioned deceleration condition is satisfied. When the deceleration condition is satisfied, the CPU determines “Yes” in step 1202, proceeds to step 1203, and sets the target deceleration parameters (ΔGtgt and Jtgt). Specifically, the CPU sets the target value ΔGtgt of the amount of change ΔG of the acceleration G to a second amount of change ΔG2, and sets the target value Jtgt of the jerk J to a second jerk J2. The second amount of change ΔG2 is smaller than the first amount of change ΔG1. The second jerk J2 is smaller than the first jerk J1. Thereafter, in step 706, the CPU controls the brake actuator 31 using the brake ECU 30 so that the deceleration parameters (here, ΔG and J) immediately after the stagnation time T match the target deceleration parameters (here, ΔG2 and J2), respectively.

Here, the situation in which there is the other vehicle behind the own vehicle VA is referred to as a “first situation”, and the situation in which no other vehicle exists behind the own vehicle VA is referred to as a “second situation”. The CPU sets the value of the deceleration parameter in the first situation smaller than the value of the deceleration parameter in the second situation. As a result, in the first situation, the CPU can reduce the degree (magnitude) of deceleration of the vehicle VA by the specific deceleration control as compared with the second situation. It is possible to reduce the possibility that the own vehicle VA approaches the other vehicle OV.

When the CPU determines “No” in step 1202, the CPU sequentially executes the processes of steps 704 and 705 as described above. That is, the CPU executes the speed maintaining control.

In another example, in the first situation, the CPU may set one of the target value ΔGtgt of the amount of change ΔG of the acceleration G and the target value Jtgt of the jerk J to be smaller than the values thereof in the second situation.

In another example, the CPU may change the deceleration parameters in the specific deceleration control in accordance with one or both of the inter-vehicle distance Din between the own vehicle VA and the other vehicle OV and the relative speed Vre of the other vehicle OV with respect to the own vehicle VA. For example, in step 1203, the CPU may apply the inter-vehicle distance Din and the relative velocity Vre to a second map M2 (Din, Vre) to set the target deceleration parameters (ΔGtgt and Jtgt). For example, the larger the inter-vehicle distance Din, the larger the target deceleration parameters (ΔGtgt and Jtgt). The smaller the relative velocity Vre, the larger the target deceleration parameters (ΔGtgt and Jtgt). In this way, the CPU sets the target deceleration parameters (ΔGtgt and Jtgt) of an appropriate degree so that the own vehicle VA does not come too close to the other vehicle OV in accordance with the inter-vehicle distance Din and the relative speed Vre.

Further, in another example, the CPU may apply the predicted time Tk (that is, TTC) to a third map M3 (Tk) to set the target deceleration parameters (ΔGtgt and Jtgt). In this configuration, the larger the predicted time Tk, the larger the target deceleration parameters (ΔGtgt and Jtgt).

### Third Modification

The driving support ECU 10 determines at least once, whether there is the other vehicle behind the own vehicle VA, during the period of the first mode (that is, the period from the time point t2 at which the control of the first mode is started to the time point t3 at which the control of the second mode is started). Then, when the driving support ECU 10 determines that there is no other vehicle behind the own vehicle VA, the driving support ECU 10 executes the specific deceleration control.

### Fourth Modification

The driving support ECU 10 may adopt as the target deceleration parameter in the specific deceleration control, either one of the target value ΔGtgt of the amount of change ΔG of the acceleration G and the target value Jtgt of the jerk J.

### Fifth Modification

In the routine in FIG. 11 or 12, when the CPU proceeds to step 706 in a situation in which there is the other vehicle OV behind the own vehicle VA, the CPU may execute the notification control in addition to the specific deceleration control. For example, the CPU may turn on the stop lamp 62 while executing the specific deceleration control.

### Sixth Modification

For example, the driving support ECU 10 may determine whether the driver is in the abnormal state by using a so-called “driver monitor technology” disclosed in Japanese Unexamined Patent Application Publication No. 2013-152700 (JP2013-152700 A). More specifically, a camera for photographing the driver may be provided on a member (for example, a steering wheel, a pillar, etc.) in a vehicle cabin. The driving support ECU 10 monitors the direction of the driver's line of sight or the direction of the face using the captured image of the camera. The driving support ECU 10 determines that the driver is in the abnormal state when the direction of the driver's line of sight or the direction of the face is continued in a direction other than the front direction. Thus, the time during which the direction of the driver's line of sight or the direction of the face is continuously facing in a direction other than the forward direction is the above-mentioned “the first duration Ti”, “the second duration T2”, and “the third duration T3”.

### Seventh Modification

In the example in FIG. 2, the warning control may be performed in the period from the time point t1 to the time point t2. For example, when the specific state is continued for the predetermined time (<Tth1) from the time point t1, the operation support ECU 10 may turn on the warning lamp on the display 72 until the time point t2 at which the operation mode shifts to the first mode. This warning lamp may be a message or mark that “prompts the holding of the steering wheel SW”.

What is claimed is:

1. A vehicle control device comprising:
an operation amount sensor that acquires information about an operation amount of a driving operator operated by a driver of an own vehicle to drive the own vehicle;
a rear sensor that detects object information that is information about an object that is in a rear region of the own vehicle; and
a control device that is configured to
repeatedly determine whether the driver is in an abnormal state in which the driver has lost an ability to drive the own vehicle while the own vehicle is traveling, based on the information about the operation amount of the driving operator,
execute a warning control to the driver when the control device determines that the driver is in an abnormal state, and
execute a stop control for stopping the own vehicle when the abnormal state is continued for a predetermined time threshold value or more from a time point at which the warning control is started,
wherein the control device is configured to
determine whether there is another vehicle behind the own vehicle, based on the object information, in a first period from the time point at which the warning control is started to a time point at which the stop control is started, and
execute a specific deceleration control for temporarily decelerating the own vehicle so as to give the driver a feeling of deceleration when the control device determines that there is no other vehicle behind the own vehicle.

2. The vehicle control device according to claim 1, wherein the control device is configured to execute a speed maintaining control for maintaining a speed of the own vehicle when the control device determines that there is the other vehicle behind the own vehicle in the first period.

3. The vehicle control device according to claim 2, wherein the control device is configured to
determine whether there is the other vehicle behind the own vehicle every time a predetermined time elapses in the first period, and
execute the specific deceleration control when the control device determines that there is no other vehicle behind the own vehicle.

4. The vehicle control device according to claim 1, wherein the control device is configured to execute the specific deceleration control, when the control device determines that a predetermined condition that is satisfied when a probability that the own vehicle approaches the other vehicle is low by the specific deceleration control is satisfied, even when the control device determines that there is the other vehicle behind the own vehicle.

5. The vehicle control device according to claim 4, wherein the control device is configured to determine whether the predetermined condition is satisfied, by using one or both of an inter-vehicle distance between the own vehicle and the other vehicle and a relative speed of the other vehicle with respect to the own vehicle.

6. The vehicle control device according to claim 4,
wherein the control device is configured to set a value of a deceleration parameter in the specific deceleration control when there is the other vehicle behind the own vehicle, to be smaller than a value when there is no other vehicle behind the own vehicle, and
wherein the deceleration parameter includes at least one of an amount of change in an acceleration of the own vehicle and a time change rate of the acceleration.

7. The vehicle control device according to claim 4,
wherein the control device is configured to change a value of a deceleration parameter in the specific deceleration control in accordance with one or both of an inter-vehicle distance between the own vehicle and the other vehicle and a relative speed of the other vehicle with respect to the own vehicle, and
wherein the deceleration parameter includes at least one of an amount of change in an acceleration of the own vehicle and a time change rate of the acceleration.
